(19) United States
(12) Patent Application Publication
(10) Pub. No.: US 2026/0075006 A1
(43) Pub. Date: Mar. 12, 2026

(54) FLOW CONTROL ASSISTANCE FOR BURSTY TRAFFIC IN A WIRELESS COMMUNICATION SYSTEM (WCS)

(71) Applicant: ANI Acquisition Sub, LLC, Boca Raton, FL (US)

(72) Inventors: Swami Dayal Srivastava, Milipitas, CA (US); Gourav Wadhawa, Fremont, CA (US)

(73) Assignee: ANI Acquisition Sub, LLC, Boca Raton, FL (US)

(21) Appl. No.: 19/323,791

(22) Filed: Sep. 9, 2025

Related U.S. Application Data
(60) Provisional application No. 63/692,833, filed on Sep. 10, 2024.

(51) Int. Cl. H04L 47/10; H04W 28/04; H04W 28/14

(52) U.S. Cl. CPC H04L 47/39; H04W 28/04; H04W 28/14

(57) ABSTRACT

Flow control assistance for bursty traffic in a wireless communication system contemplates a radio link control (RLC) sublayer that may control credits issued to a packet data convergence protocol (PDCP) sublayer to control how many packets the PDCP sublayer may send to the RLC sublayer. As the PDCP sublayer sends packets to the RLC sublayer, the PDCP sublayer tracks (and decrements) an internal count of available (unredeemed) credits. Concurrently, the RLC sublayer tracks (and decrements) issued credits as packets are received (effectively redeemed) at the RLC sublayer from the PDCP sublayer. When the tally of unredeemed credits falls below a threshold, the RLC sublayer issues new credits, which the PDCP sublayer adds to its internal tally. Further, the RLC sublayer may have an inactivity timer which causes some credits (up to a calculated maximum) to be sent to the PDCP sublayer even if the threshold has not been passed.

### CROSS-REFERENCE TO RELATED APPLICATIONS

This application claims the benefit of priority under 35 U.S.C. § 119(e) of U.S. Provisional Application No. 63/692,833, filed Sep. 10, 2024, the contents of which are incorporated herein by reference in its entirety.

### BACKGROUND

The disclosure relates generally to handling packet transfer from a packet data convergence protocol (PDCP) sublayer to a radio link control (RLC) sublayer and, more particularly, to handling service data unit (SDU) packets in a radio access network (RAN) as defined by 3GPP.

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communication systems have been provided to transmit and/or distribute communication signals to wireless devices called “clients,” “client devices,” or “wireless client devices,” which must reside within the wireless range or “cell coverage area” to communicate with an access point device. Example applications where communication systems can be used to provide or enhance coverage for wireless services include public safety, cellular telephony, wireless local access networks (LANs), location tracking, and medical telemetry inside buildings and over campuses. One approach to deploying a communication system involves the use of a radio node/base station that transmits communication signals distributed over physical communication medium remote unit forming radio frequency (RF) antenna coverage areas, also referred to as “antenna coverage areas. ” The remote units each contain or are configured to couple to one or more antennas configured to support the desired frequency(ies) of the radio node to provide the antenna coverage areas. Antenna coverage areas can have a radius in the range from a few meters up to twenty meters, as an example. Another example of a communication system includes radio nodes, such as base stations, that form cell radio access networks, wherein the radio nodes are configured to transmit communication signals wirelessly directly to client devices without being distributed through intermediate remote units.

In many instances, communication occurs between elements of the communication system through packets. Managing the packet flows so that no packets are dropped, particularly when the packet traffic is bursty, provides room for innovation.

### SUMMARY

Aspects disclosed herein include systems and methods for flow control assistance for bursty traffic in a wireless communication system (WCS), and related methods. In exemplary aspects, the WCS includes a flow management process that is configured to assist in managing packet transfer between protocol sublayers within the WCS. A processor in a device may host a radio link control (RLC) sublayer that controls credits issued to a processor that hosts a packet data convergence protocol (PDCP) sublayer to control how many packets the PDCP sublayer may send to the RLC sublayer. As the PDCP sublayer sends packets to the RLC sublayer, the PDCP sublayer tracks (and decrements) an internal count of available (unredeemed) credits. Concurrently, the RLC sublayer tracks (and decrements) issued credits as packets are received (effectively redeemed) at the RLC sublayer from the PDCP sublayer. When the tally of unredeemed credits falls below a threshold, the RLC sublayer issues new credits, which the PDCP sublayer adds to its internal tally. In this fashion, “in-flight” packets (i.e., sent but not yet received) are already removed from the PDCP sublayer's internal tally but not yet counted by the RLC sublayer, preventing the RLC sublayer from sending too many credits to the PDCP sublayer. Further, the RLC sublayer may have an inactivity timer which causes some credits (up to a calculated maximum) to be sent to the PDCP sublayer even if the threshold has not been passed. This pre-emptive sending of credits allows the PDCP to have a buffer of credits to accommodate bursty traffic.

In a first aspect, a wireless communication system (WCS) is disclosed. The WCS includes a remote antenna unit (RAU) configured to communicate with user equipment in a service area and a distribution unit (DU) communicatively coupled to the RAU and comprising a DU processor comprising a radio link control (RLC) sublayer. The RLC sublayer is configured to send an initial credit value to a packet data convergence protocol (PDCP) sublayer, track redemption of credits by the PDCP sublayer as evidenced by receipt of packets, determine whether the redemption of credits causes a local credit value to pass a threshold and in response to the redemption of credits causing the local credit value to pass the threshold, send additional credits to the PDCP sublayer. The WCS also includes a central unit (CU) comprising a CU processor comprising the PDCP sublayer. The PDCP sublayer is configured to receive the initial credit value from a radio link control (RLC) sublayer, decrement the initial credit value based on packets sent from the PDCP sublayer to the RLC sublayer to create a remaining credit value, receive a subsequent credit value from the RLC sublayer, and in response to receipt of the subsequent credit value from the RLC sublayer, add the subsequent credit value to the remaining credit value.

In a further aspect, a device in a WCS is disclosed. The WCS includes a processor comprising a radio link control (RLC) sublayer. The RLC sublayer is configured to send an initial credit value to a packet data convergence protocol (PDCP) sublayer, track redemption of credits by the PDCP sublayer as evidenced by receipt of packets, determine whether the redemption of credits causes a local credit value to pass a threshold and in response to the redemption of credits causing the local credit value to pass the threshold, send additional credits to the PDCP sublayer.

In a further aspect, a device in a WCS is disclosed. The device includes a processor comprising a packet data convergence protocol (PDCP) sublayer. The PDCP sublayer is configured to receive an initial credit value from a radio link control (RLC) sublayer, decrement the initial credit value based on packets sent from the PDCP sublayer to the RLC sublayer to create a remaining credit value, and receive a subsequent credit value from the RLC sublayer; in response to receipt of the subsequent credit value from the RLC sublayer, add the subsequent credit value to the remaining credit value.

In a further aspect, a method of controlling packet flow in a WCS is disclosed. The method includes sending an initial credit value from a radio link control (RLC) sublayer to a packet data convergence protocol (PDCP) sublayer at the PDCP sublayer, receiving the initial credit value from the RLC sublayer, sending packets from the PDCP sublayer to the RLC sublayer, in response to sending packets, decrement the initial credit value at the PDCP sublayer by a number of packets sent, in response to receiving packets at the RLC sublayer, tracking redemption of credits by the PDCP sublayer, and determining whether the redemption of credits causes a local credit value to pass a threshold. The method also includes, in response to the redemption credits causing the local credit value at the RLC sublayer to pass a threshold, sending additional credits to the PDCP sublayer.

Additional features and advantages will be set forth in the detailed description that follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more embodiment(s) and, together with the description, serve to explain the principles and operation of the various embodiments.

### BRIEF DESCRIPTION OF THE DRAWINGS

FIG. 1 is a block diagram of an exemplary wireless communication system (WCS), such as a distributed communication system (DCS), configured to distribute communication services to remote coverage areas;

FIG. 2 is a block diagram illustrating packet and credit exchange between a radio link control (RLC) sublayer and packet data convergence protocol (PDCP) sublayer;

FIGS. 3A-3D illustrate alternate locations for the RLC sublayer and the PDCP sublayer consolidated into elements of the WCS of FIG. 1;

FIG. 4 is a flowchart showing a decision-making process by the RLC sublayer for issuing credits to the PDCP sublayer;

FIG. 5 is a flowchart showing a process used by the PDCP sublayer responsive to the credits issued by the RLC sublayer;

FIG. 6 is a message flow exchange between the RLC sublayer and the PDCP sublayer based on the flowcharts of FIGS. 5 & 6;

FIG. 7 is a block diagram of elements within the RLC sublayer and the PDCP sublayer to implement aspects of the present disclosure;

FIG. 8 is an exemplary multi-radio WCS in the form of an exemplary radio access network (RAN) having central units (CU) and distribution units (DU) that support the RLC sublayer and PDCP sublayer, and that is configured to support a plurality of radio units (RUs) providing a cell to service user devices as subscriber devices in the communication range of the RU(s);

FIG. 9 is a schematic diagram of another exemplary multi-radio WCS, having a variety of CU and DU supporting the present disclosure;

FIG. 10 is a partial schematic cut-away diagram of an exemplary building infrastructure that includes a multi-radio WCS that may be supported by the flow control of the present disclosure;

FIG. 11 is a schematic diagram of an exemplary mobile telecommunication environment that includes a multi-radio WCS; and

FIG. 12 is a schematic diagram of a representation of an exemplary computer system that can be included in or interfaced with any of the components in a multi-radio WCS.

### DETAILED DESCRIPTION

Aspects disclosed herein include systems and methods for flow control assistance for bursty traffic in a wireless communication system (WCS), and related methods. In exemplary aspects, the WCS includes a flow management process that is configured to assist in managing packet transfer between protocol sublayers within the WCS. A processor in a device may host a radio link control (RLC) sublayer that controls credits issued to a processor that hosts a packet data convergence protocol (PDCP) sublayer to control how many packets the PDCP sublayer may send to the RLC sublayer. As the PDCP sublayer sends packets to the RLC sublayer, the PDCP sublayer tracks (and decrements) an internal count of available (unredeemed) credits. Concurrently, the RLC sublayer tracks (and decrements) issued credits as packets are received (effectively redeemed) at the RLC sublayer from the PDCP sublayer. When the tally of unredeemed credits falls below a threshold, the RLC sublayer issues new credits, which the PDCP sublayer adds to its internal tally. In this fashion, “in-flight” packets (i.e., sent but not yet received) are already removed from the PDCP sublayer's internal tally but not yet counted by the RLC sublayer, preventing the RLC sublayer from sending too many credits to the PDCP sublayer. Further, the RLC sublayer may have an inactivity timer which causes some credits (up to a calculated maximum) to be sent to the PDCP sublayer even if the threshold has not been passed. This pre-emptive sending of credits allows the PDCP to have a buffer of credits to accommodate bursty traffic.

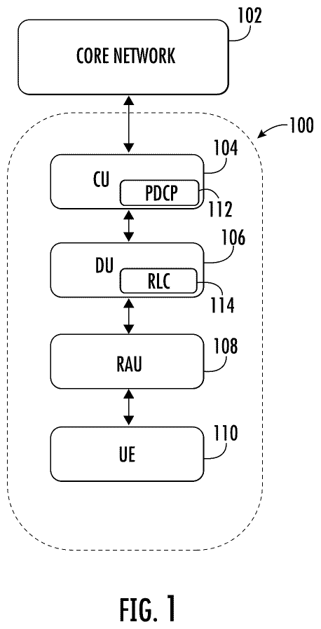

More complete descriptions of a WCS begin below with respect to FIG. 8. However, such a description is not required for an understanding of aspects of the present disclosure. Thus, FIG. 1 is a block diagram of a simple WCS 100, which may, for example, be a FR1 and/or FR2 Radio Access Network as generally defined by 3GPP. The WCS 100 may communicate with a core network 102, which may send packets to a central unit (CU) 104 of the WCS 100. It is these packets and the management thereof that form the basis of this disclosure. Before addressing packet management and flow control assistance of bursty traffic, additional details about the WCS 100 are provided. Thus, the CU 104 may communicate with a distribution unit (DU) 106. The DU 106 communicates with a remote antenna unit (RAU) 108, which includes an antenna, and wirelessly communicates with user equipment (UE) 110 within a service area reachable by signals emitted from the antenna.

The UE 110 may, for example, be a smartphone or the like and be capable of two-way communication. The present disclosure focuses on downlink activity from the core network 102 to the UE 110 and, more specifically, on the communication between a PDCP sublayer 112 in the CU 104 and an RLC sublayer 114 in the DU 106.

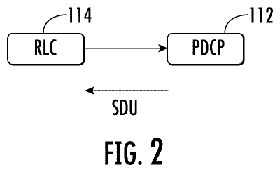

That is, in the absence of the present disclosure, packets intended to be received at the UE 110 are sent from the core network 102 to the CU 104. The RLC sublayer 114 controls when and how it receives packets (e.g., the service data units (SDUs)) by sending credits to the PDCP sublayer 112. In conventional systems, the RLC sublayer 114 provides an initial allocation of credits to the PDCP sublayer 112 corresponding to a volume of packets that the RLC sublayer 114 is capable of processing without losing packets. As the PDCP sublayer 112 sends packets, the number of credits at the PDCP sublayer 112 is decremented (see generally FIG. 2). Periodically, the RLC sublayer 114 sends a new allocation of credits to the PDCP sublayer 112. The PDCP sublayer 112 discards any remaining credits and relies on the new credit allocation in determining if the PDCP sublayer 112 may send packets to the RLC sublayer 114. Problems can arise when the PDCP sublayer 112 has sent packets relying on a current credit count, and then, while those packets are still “in-flight” (i.e., not yet received or processed by the RLC sublayer 114), receiving a new credit allocation from the RLC sublayer 114. The PDCP sublayer 112 then receives a large burst of packets from the core network 102. Seeing the new credit allocation, the PDCP sublayer 112 diligently sends the new packets to the RLC sublayer 114. The RLC sublayer 114 then receives the inflight packets and the new packets at volumes exceeding its ability to process the packets, and some packets are dropped. While this sequence of events may seem like a corner case, such bursts occurring on top of in-flight packets occur frequently enough to impact the user experience negatively.

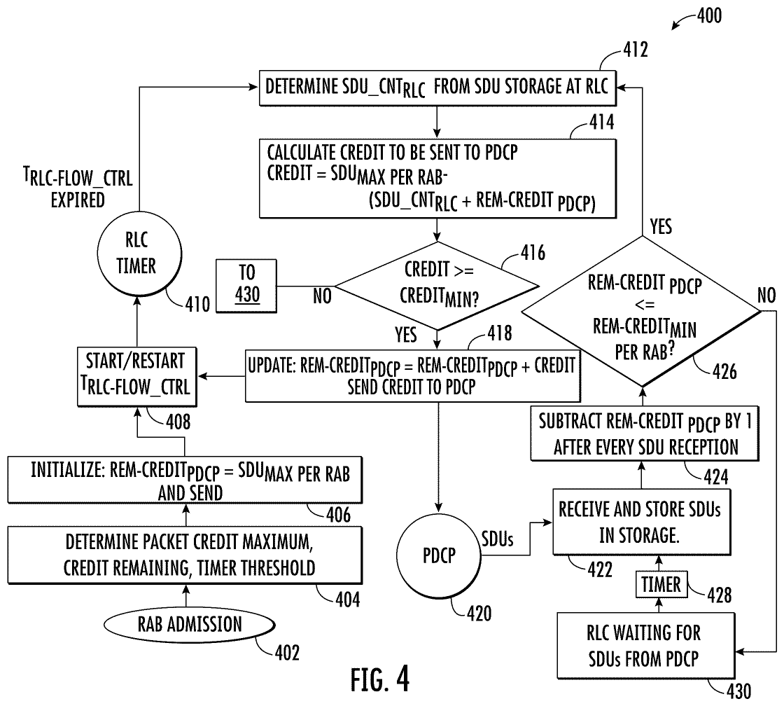

Aspects of the present disclosure provide flow control assistance for this sort of bursty traffic. More specifically, aspects of the present disclosure change how the PDCP sublayer 112 and the RLC sublayer 114 handle credit allocation by having the RLC sublayer 114 track credits sent to the PDCP sublayer 112. Thus, the RLC sublayer 114 will decrement a credit count as packets are received and send credits when the count drops below a threshold. The PDCP sublayer 112 will, instead of discarding unused credits, add the new credits to a running credit tally. Additional provisions are made for interrupting packet flow or replenishing a credit count even if the threshold has not been passed. The discussion of the details begins below with reference to FIG. 4.

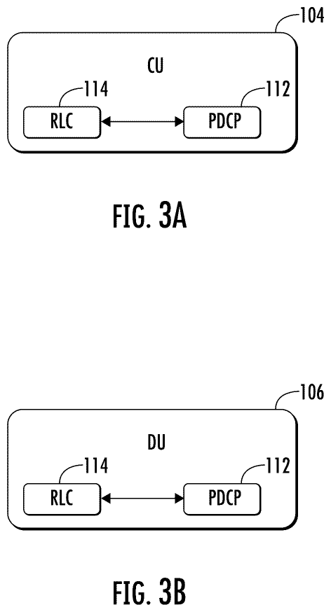

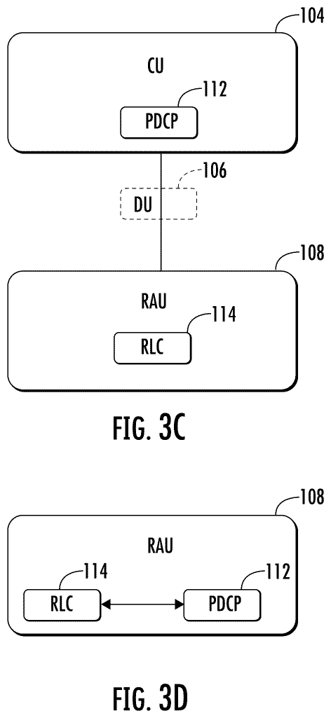

Note that while conventional systems place the RLC sublayer 114 in the DU 106 and the PDCP sublayer 112 in the CU 104, aspects of the present disclosure also work with alternate deployments, including situations where the PDCP sublayer 112 and the RLC sublayer 114 are in the CU 104 as shown in FIG. 3A or situations where the PDCP sublayer 112 and the RLC sublayer 114 are in the DU 106, as shown in FIG. 3B.

Still other networks may place the PDCP sublayer 112 in the CU 104 with the RLC sublayer 114 in the RAU 108, as shown in FIG. 3C. This situation may occur in frequency range 2/millimeter wave (FR2/MMW) radio units. Still another option is illustrated in FIG. 3D, where the RAU 108 includes both the PDCP sublayer 112 and the RLC sublayer 114.

FIG. 4 provides a flowchart of a process 400 for providing flow control assistance for bursty traffic. The process 400 begins with a radio access bearer (RAB) being admitted to the RLC sublayer 114 (block 402). The RLC sublayer 114 determines a packet credit maximum, a credit remaining at the PDCP sublayer 112 (as tracked by the RLC sublayer 114), and a timer threshold (block 404) per RAB. These variables are sometimes referred to as SDU_{MAX per RAB}, REM-CREDIT_{MIN per RAB}, and T_{RLC-FLOW_CTRL}. In exemplary aspects, the SDU_{MAX per RAB} may be 6000, the REM-CREDIT may be 700, and the timer threshold may be 300 milliseconds. These values may vary depending on memory available per RAB, network metrics of expected traffic, or the like. While these values are used to illustrate specific examples, it should be appreciated that the precise values are not central to the disclosure.

The RLC sublayer 114 may then initialize the credit remaining for a PDCP sublayer 112 by setting it to the packet credit maximum and sending these credits to the PDCP sublayer 112 (block 406). In one exemplary aspect, the PDCP sublayer 112 may receive this information during RAB admission. Alternatively, this information may be shared during the configuration of the PDCP sublayer 112. Either way, REM-CREDIT_{pdcp}=SDU_{MAX per RAB}. This causes the RLC sublayer 114 to know that the PDCP sublayer 112 has a full allocation of credits. The RLC sublayer 114 may start the timer (block 408). The timer may count up or down and based off the previously determined T_{RLC-FLOW_CTRL}. Once the timer expires (block 410), the RLC sublayer 114 determines a packet received count based on packet storage at the RLC sublayer 114 (block 412). The packet received count may be referred to as SDU_CNT_{RLC}. Initially this is zero, as no packets have been received, but over time, this value will rise. The RLC sublayer 114 calculates a credit to be sent to the PDCP sublayer 112 for this RAB (block 414). This calculation may be expressed as CREDI =SDU_{MAX per RAB}−(SDU_CNT_{RLC}+REM-CREDIT_{pdcp}) or the amount of credit to be sent is equal to the maximum credit minus the sum of (packets received and the remaining credits).

If CREDIT is greater than or equal to a minimum credit (block 416) that can be sent (this is done to prevent using lots of messages to send small credit amounts to the PDCP sublayer 112), then the RLC sublayer 114 updates the remaining credit by adding CREDIT to REM-CREDIT and sends an amount of credits to the PDCP sublayer 112 (block 418). Note that this restarts the timer (block 408). After sending the credits to the PDCP sublayer 112, the PDCP sublayer 112 sends packets to the RLC sublayer 114 (block 420), which are received and stored in the local storage (block 422). The RLC sublayer 114 will subtract one (1) from REM-CREDIT_{pdcp} after every packet is received (block 424) reflecting the redemption of the credit.

The RLC sublayer 114 then determines if REM-CREDIT_{pdcp} is less than or equal to REM-CREDITₘᵢₙ (block 426). This checks to see if the RLC sublayer 114 has received enough packets and has effectively redeemed the credits issued to the PDCP sublayer 112 that it is time to send more credits to the PDCP sublayer 112. Thus, if the answer to block 426 is yes, then the process 400 goes to block 412 to recalculate SDU_CNT_{RLC} and recalculate CREDIT. However, if the answer to block 426 is no, then process 400 goes to block 430 where the RLC sublayer 114 is waiting for SDUs from the PDCP sublayer 112. Note also that if the answer to block 416 is no, then the process 400 also goes to block 430. Note that there is a general interruption of this process 400 that occurs when the timer expires (block 428) without any packets being received. In such an event, the RLC sublayer 114 may see if REM_CREDIT_{pdcp}<SDU_{MAX} and, if so, send some number of credits to the PDCP sublayer 112 even if the REM_CREDIT_{MIN} threshold has not been reached. This preemptive sending allows for gradual replenishment of credits at the PDCP sublayer 112 to provide a cushion for bursty traffic. It should be appreciated that checking for timer expiration may take place at other locations/times in the process 400. Likewise, the number of credits sent to the PDCP sublayer 112 may be varied according to a variety of different formulas and may, for example, be based on normal traffic pattern metrics.

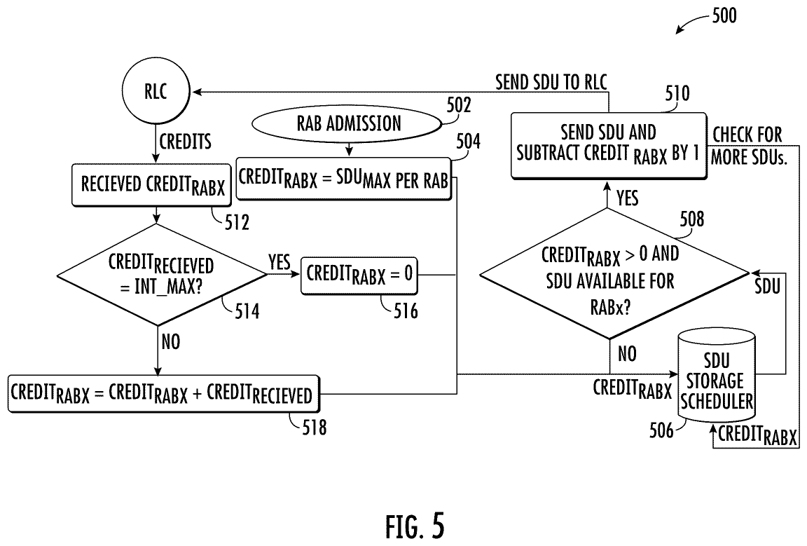

FIG. 5 provides a flowchart of a process 500 used by the PDCP sublayer 112. The process 500 begins with RAB admission (block 502). The credits for the PDCP sublayer 112 (CREDIT_{RABx}) are set at the SDU_{MAX} (block 504), either because the PDCP sublayer 112 knows this value a priori or because the RLC sublayer 114 provides this information. The PDCP sublayer 112 receives packets from the core network 102 and schedules them for transmission to the RLC sublayer 114 (block 506). The PDCP sublayer 112 checks to see if the CREDIT_{RABx}>0 and there is a packet available for that RAB (block 508). If either condition fails, the process 500 returns to block 506. If, however, both conditions are met, the PDCP sublayer 112 sends the packet and subtracts one from CREDIT_{RABx} (block 510). The process 500 continues in two parts at this point. The first part checks to see if there are more packets to send (i.e., returning to block 506). The second part depends on the RLC sublayer 114 sending credits (as determined and explained in process 400) such that the PDCP sublayer 112 receives credits (block 512).

Note that the RLC sublayer 114 may have an override option that causes the PDCP sublayer 112 to stop sending packets regardless of how many credits were available. In this regard, the process 500 checks to see if the credits received from the RLC sublayer equal an interrupt value (block 514). In an exemplary aspect, this interrupt value is set equal to a maximum integer value that can be represented by the CREDIT datatype. If this value is received, then CREDIT_{RABx} is set to zero (block 516) such that there are no credits available at block 508 and all packet transmissions stop. If, however, a non-interrupt value of credits is received, the PDCP sublayer 112 adds the CREDIT_{received} to CREDIT_{RABsx} to get a new CREDIT_{RABx}.

Note that both process 400 and process 500 run in parallel for each RAB (thus explaining the RABx notation) and different processes for different RAB may be at different points concurrently without departing from the present disclosure.

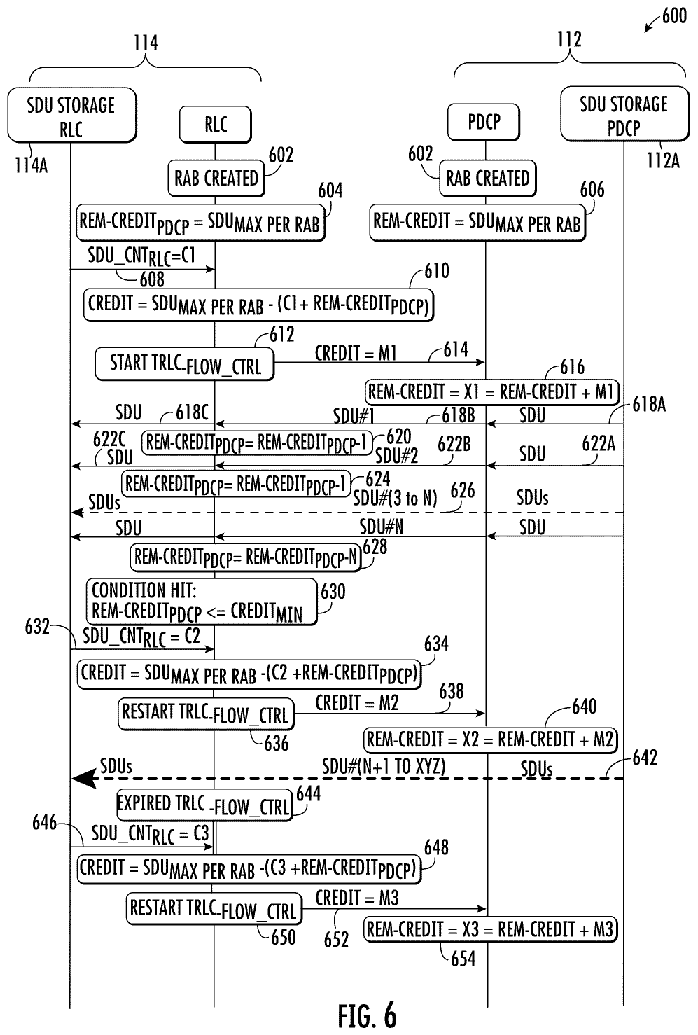

FIG. 6 shows a combined event and message chart 600 that combines the processes 400 and 500. Specifically, the chart 600 begins when a RAB is created 602. The RLC sublayer 114 sets the REM-CREDIT_{pdcp} at the SDU_{MAX} 604. Similarly, the PDCP sublayer 112 sets its local REM-CREDIT at SDU_{MAX} 606. Again, note this is per RAB. The RLC sublayer 114 gets the SDU_CNT_{RLC}=C1 from the RLC SDU storage 114A (signal 608). C1 equals zero initially in most implementations. The RLC sublayer 114 calculates CREDIT=SDU_{MAX}−(C1+REM-CREDIT_{pdcp}) 610. The timer starts 612 and M1 credits are sent to the PDCP sublayer 112 (signal 614). The PDCP sublayer 112 updates REM-CREDIT=X1=REM-CREDIT+M1 616. Packets are received from the core network 102 (not shown in FIG. 6) and put into the PDCP SDU storage 112A. A first packet is then pulled from the PDCP SDU storage 112A (signal 618A) and sent to the RLC sublayer 114 (signal 618B) and stored in the RLC SDU storage 114A (signal 618C). The RLC sublayer 114 then updates REM-CREDIT_{pdcp} by decrementing it by one (1) 620.

A second packet is then pulled from the PDCP SDU storage 112A (signal 622A) and sent to the RLC sublayer 114 (signal 622B) and stored in the RLC SDU storage 114A (signal 622C). The RLC sublayer 114 then updates REM-CREDIT_{pdcp} by decrementing it by one (1) 624. This may repeat N times 626 until the Nth packet is sent and REM-CREDIT_{pdcp} has been decremented N times 628 (where decrementing occurs one at a time per each packet) reflecting redeemed credits. While note shown, REM-CREDIT is also decremented each time a packet is sent.

At some point, REM-CREDIT_{pdcp} is less than or equal to the CREDIT_{MIN} 630 and the RLC SDU storage 114A updates SDU_CNT_{RLC} to C2 (signal 632). Responsive to this signal, the RLC sublayer 114 updates CREDIT=SDU_{MAX}−(C2 +REM-CREDIT_{pdcp}) 634 and restarts the timer 636 while sending CREDIT=M2 to the PDCP sublayer 112 (signal 638). Responsive to signal 638, the PDCP sublayer 112 updates REM-CREDIT=X2=REM-CREDIT+M2 640. Additional packets are sent 642, and eventually there will be enough of a gap that the timer expires 644. The RLC SDU storage 114A sends a signal 646 that sets SDU_CNT_{RLC}=C3. The RLC sublayer 114 calculates a new CREDIT=SDU_{MAX}−(C3+REM-CREDIT_{pdcp}) 648. The timer is restarted 650, and a new credit value M3 is sent to the PDCP sublayer 112 (signal 652). The PDCP sublayer 112 updates REM-CREDIT=X3=REM-CREDIT +M3 654. Variations will be readily apparent to the interested reader and are included within the scope of the present disclosure.

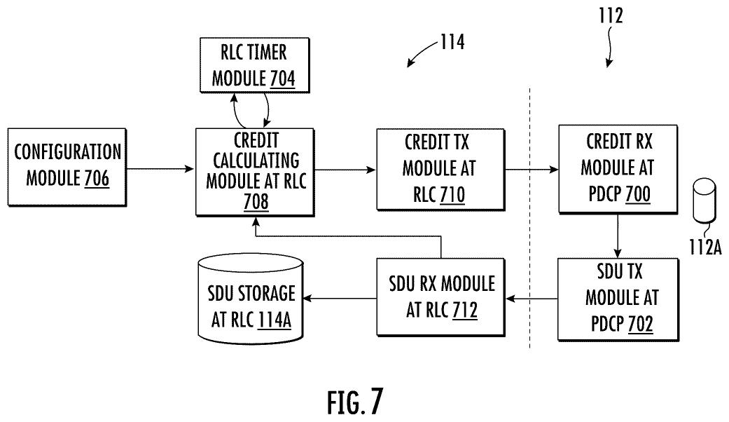

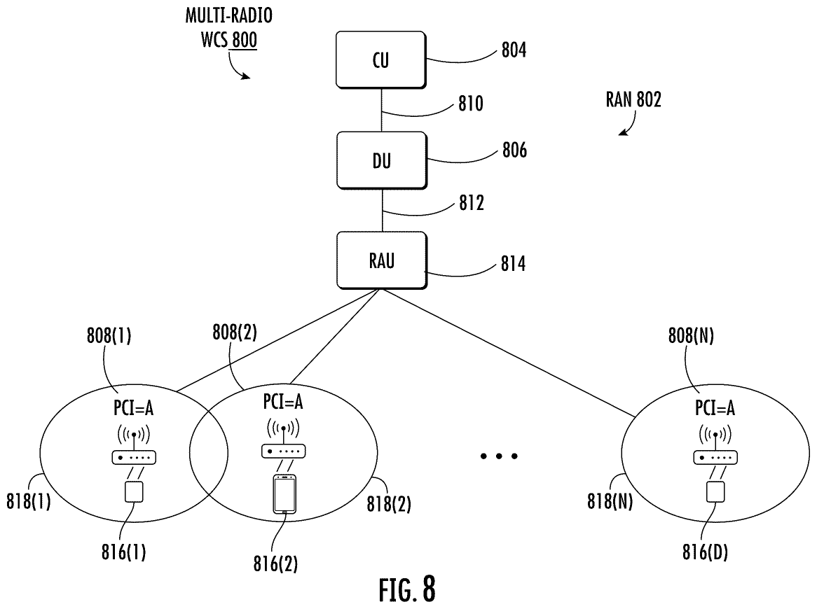

FIG. 7 illustrates additional details about the PDCP sublayer 112 and the RLC sublayer 114. Specifically, the PDCP sublayer 112 may include a credit received module 700. and a packet transmit module 702, along with the PDCP SDU storage 112A. The RLC sublayer 114 may include a timer 704, a configuration module 706, a credit calculating module 708, a credit transmit module 710, as well as a packet receive module 712. The functions of these modules are set forth in the naming and should readily map to the activities of process 400, process 500, and signal chart 600.

While the above description has been fairly focused on the CU 104, the DU 106, the PDCP sublayer 112, and the RLC sublayer 114, these elements do not exist in isolation. FIG. 1 provides a rudimentary discussion of a WCS 100. The following figures provide additional details about parts of the WCS and where within the WCS, aspects of the present disclosure can be found.

The WCS 100 of FIG. 1 can be included as part of a multi-radio WCS, which may be a radio access network (RAN). For example, one type of RAN is Open-RAN (O-RAN), which is a RAN that is compatible with a set of specifications that specifies multiple options for functional divisions of a cellular base station between physical units, and it also specifies the interface between these units. An example of a multi-radio WCS 800, which is RAN 802, is shown in FIG. 8. In the multi-radio WCS 800, the functionality of the base station (e.g., gNB, as called in the context of 5G) is divided into three functional units of a central unit (CU) 804 (where the PDCP sublayer 112 can be found) a distribution unit (DU) 806 (where the RLC sublayer 114 can be found) and one or more remote nodes, also called radio units (RUs) 808(1)-808(N) to provide a cell for cell service ‘A,’ where ‘N’ can represent any number of RUs. These components may run on different hardware platforms and reside at different locations. The RUs 808(1)-808(N) include the lowest layers of the base station, and it is the entity that wirelessly transmits and receives signals to user devices 816(1)-816(D) in the communication range of a given RU 808(1)-808(N). The CU 804 includes the highest layers of the base station and is coupled to a “core network” of the cellular service provider. The DU 806 includes the middle layers of the base station to provide support for a single cellular service provider (also known as operator or carrier). An F1 interface 810 is connected between the CU 804 and the DU 806 and carries the signals between the PDCP sublayer 112 and the RLC sublayer 114. An eCPRI fronthaul interface 812 connects the DU 806 and the RUs 808(1)-808(N).

The DU 806 is coupled to a cluster of RUs 808(1)-808(N) that serve a cell ‘A’ of the DU 806. A “cell” in this context is a set of signals intended to serve subscriber units (e.g., cellular devices) in a certain area. The multiple RUs 808(1)-808(N) are supported in the RAN 802 by what is referred to as “Shared-Cell” by a radio aggregation unit 814 (e.g., a front-haul multiplexer (FHM)) placed between the DU 806 and the RUs 808(1)-808(N). The radio aggregation unit 814 de-multiplexes (i.e. de-aggregates) downlink communication signals from the DU 806 and split by the radio aggregation unit 814 to be distributed as downlink communication signals to the RUs 808(1)-808(N). The downlink communication signals are communicated to respective user devices 816(1)-816(D) in communication range within a respective cell coverage area 818(1)-818(N) of a given RU 808(1)-808(N) and multiplexes (i.e., aggregates or sums) uplink communication signals transmitted by the user devices 816(1)-816(D) to a RU(s) 808(1)-808(N), which are then distributed from the RUs 808(1)-808(N) to DU 806 and CU 804. The radio aggregation unit 814 can be considered as a RU with front haul support and additional copy-and-combine function but lacks the RF front-end capability. The radio aggregation unit 814 multiplexes (i.e., sums) the uplink communication signals received from each of the RUs 808(1)-808(N) as part of the same cell to provide to the DU 806.

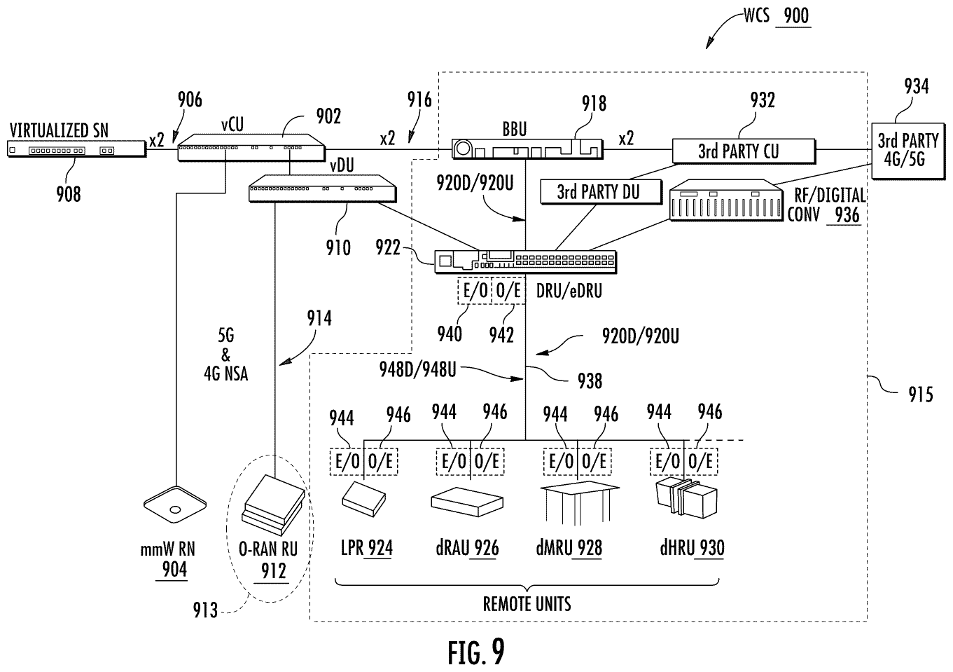

FIG. 9 is a schematic diagram of an exemplary multi-radio WCS 900 (“WCS 900”) that can include one or RAN systems implemented according to a RAN standard (e.g., O-RAN standard. The multi-radio WCS 900 supports both legacy 4G LTE, 4G/5G non-standalone (NSA), and 5G standalone communication systems. As shown in FIG. 9, a centralized services node 902 (which can be a CU described above) is provided that is configured to interface with a core network to exchange communication data and distribute the communication data as radio signals to remote units, which can be the RUs described above. In this example, the centralized services node 902 is configured to support distributed communication services to an mmWave radio node 904. The mmWave radio node 904 is an example of a wireless device that can be configured to selectively control whether received transmit channels are transmitted through an antenna array. Despite only one mmWave radio node 904 being shown in FIG. 9, it should be appreciated that the multi-radio WCS 900 can be configured to include additional mmWave radio nodes 904, as needed. The functions of the centralized services node 902 can be virtualized through an x2 interface 906 to another services node 908. The centralized services node 902 can also include one or more internal radio nodes that are configured to be interfaced with a DU 910 (which can be a virtual DU and/or a DU described above) to distribute communication signals (e.g., communication channels) to a plurality of O-RAN RUs 912 (only one RU shown for convenience) that are configured to be communicatively coupled through an O-RAN interface 914. The O-RAN RUs 912 are another example of a wireless device that can be configured to selectively control whether received transmit channels are transmitted through an antenna array. The O-RAN RUs 912 are each configured to communicate downlink and uplink communication signals in the coverage cell(s) 913.

The centralized services node 902 can also be interfaced with a DCS 915 through an x2 interface 916. Specifically, the centralized services node 902 can be interfaced with a digital baseband unit (BBU) 918 in the DCS that can provide a digital signal source to the centralized services node 902. The digital BBU 918 may be configured to provide a signal source to the centralized services node 902 to provide electrical downlink communication signals 920D (electrical downlink communication signals 920D can include downlink channels) to a digital routing unit (DRU) 922 as part of a digital DAS. The DRU 922 is configured to split and distribute the electrical downlink communication signals 920D to different types of remote wireless devices, including a low-power remote unit (LPR) 924, a radio antenna unit (dRAU) 926, a mid-power remote unit (dMRU) 928, and/or a high-power remote unit (dHRU) 930. The DRU 922 is also configured to combine electrical uplink communication signals 920U (electrical uplink communication signals 920U can include uplink channels) received from the LPR 924, the dRAU 926, the dMRU 928, and/or the dHRU 930 and provide the combined electrical uplink communication signals 920U to the digital BBU 918. The digital BBU 918 is also configured to interface with a third-party central unit 932 and/or an analog source 934 through a radio frequency (RF)/digital converter 936.

The DRU 922 may be coupled to the LPR 924, the dRAU 926, the dMRU 928, and/or the dHRU 930 via an optical fiber-based communication medium 938. In this regard, the DRU 922 can include a respective electrical-to-optical (E/O) converter 940 and a respective optical-to-electrical (O/E) converter 942. Likewise, each of the LPR 924, the dRAU 926, the dMRU 928, and the dHRU 930 can include a respective E/O converter 944 and a respective O/E converter 946.

The E/O converter 940 at the DRU 922 is configured to convert the electrical downlink communication signals 920D into optical downlink communication signals 920D for distribution to the LPR 924, the dRAU 926, the dMRU 928, and/or the dHRU 930 via the optical fiber-based communication medium 938. The O/E converter 950 at each of the LPR 924, the dRAU 926, the dMRU 928, and/or the dHRU 930 is configured to convert the optical downlink communication signals 920D back to the electrical downlink communication signals 920D. The E/O converter 944 at each of the LPR 924, the dRAU 926, the dMRU 928, and the dHRU 930 is configured to convert the electrical uplink communication signals 920U into optical uplink communication signals 920U. The O/E converter 942 at the DRU 922 is configured to convert the optical uplink communication signals 920U back to the electrical uplink communication signals 920U.

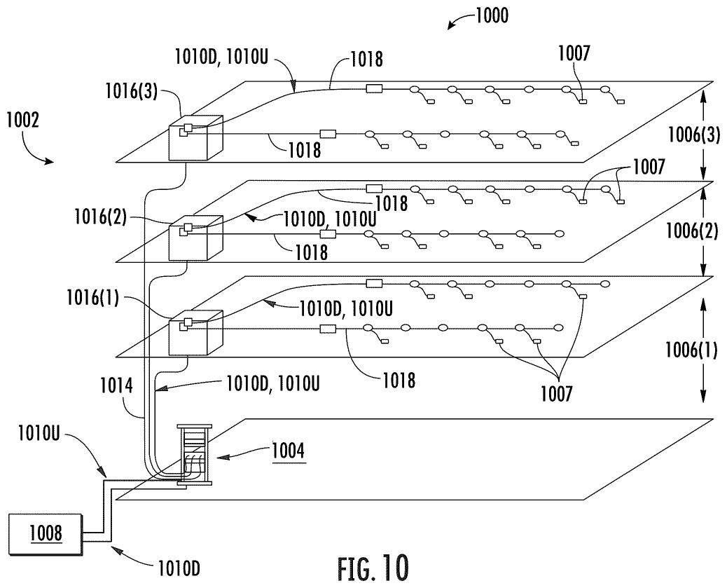

FIG. 10 is a partial schematic cut-away diagram of an exemplary building infrastructure 1000 that includes an exemplary multi-radio WCS 1002, wherein the multi-radio WCS 1002 includes multiple RANs 1004 implemented according to a RAN standard (e.g., O-RAN standard). The building infrastructure 1000 in this embodiment includes a first (ground) floor 1006(1), a second floor 1006(2), and a third floor 1006(3). The floors 1006(1)-1006(3) are serviced by one or more RANs 1004 to provide antenna coverage areas 1007 in the building infrastructure 1000. The RANs 1004 are communicatively coupled to a core network 1008 to receive downlink communication signals 1010D (downlink communication signals 1010D can include downlink channels) from the core network 1008. The RANs 1004 are communicatively coupled to a respective plurality of RUs 1012 to distribute the downlink communication signals 1010D to the RUs 1012 and to receive uplink communication signals 1010U (uplink communication signals 1010U can include uplink channels) from the RUs 1012, as previously discussed above. Any RU 1012 can be shared by any of the multiple RANs 1004.

The downlink communication signals 1010D and the uplink communication signals 1010U communicated between the RANs 1004 and the RUs 1012 are carried over a riser cable 1014. The riser cable 1014 may be routed through interconnect units (ICUs) 1016(1)-1016(3) dedicated to each of the floors 1006(1)-1006(3) that route the downlink communication signals 1010D and the uplink communication signals 1010U to the RUs 1012 and also provide power to the RUs 1012 via array cables 1018.

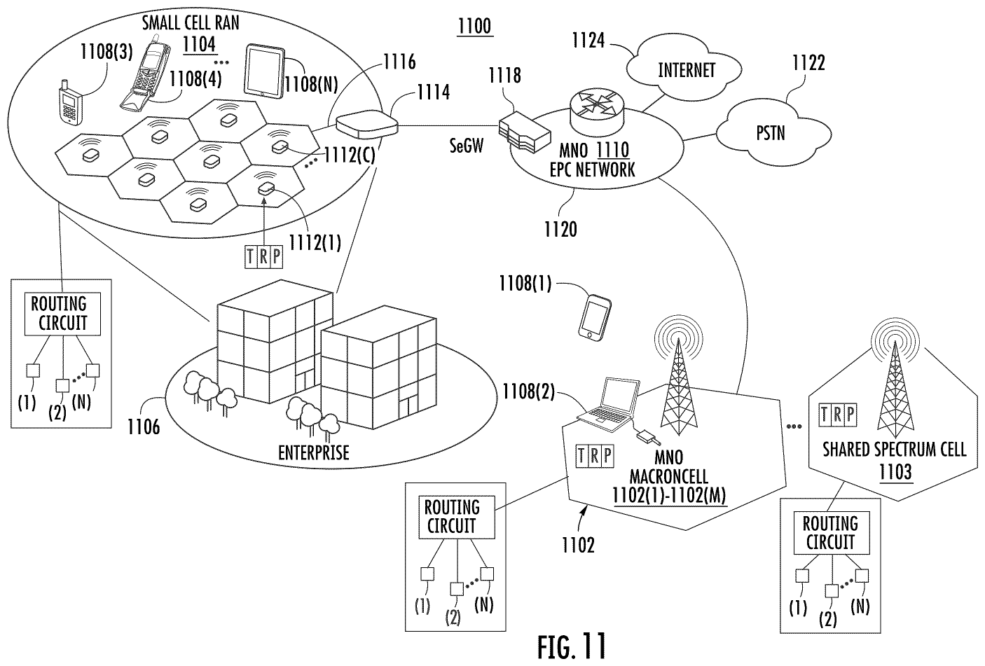

FIG. 11 is a schematic diagram of an exemplary mobile telecommunication multi-radio WCSs 1100 that can include. The multi-radio WCS 1100 includes multiple RANs implemented according to a RAN standard (e.g., O-RAN standard).

In this regard, multi-radio WCS 1100 includes exemplary macrocell RANs 1102(1)-1102(M) (“macrocells 1102(1)-1102(M)”) and an exemplary small cell RAN 1104 located within an enterprise environment 1106 and configured to service mobile communication between a user mobile communication device 1108(1)-1108(N) to a mobile network operator (MNO) 1110. A serving RAN for the user mobile communication devices 1108(1)-1108(N) is a RAN or cell in the RAN in which the user mobile communication devices 1108(1)-1108(N) have an established communication session with the exchange of mobile communication signals for mobile communication. Thus, a serving RAN may also be referred to herein as a serving cell. For example, the user mobile communication devices 1108(3)-1108(N) in FIG. 11 are being serviced by the small cell RAN 1104, whereas the user mobile communication devices 1108(1) and 1108(2) are being serviced by the macrocell 1102. The macrocell 1102 is an MNO macrocell in this example. The macrocell 1102 can be or include a wireless device(s) that can be configured to selectively control whether received transmit channels are transmitted through an antenna array of the wireless device. However, a shared spectrum RAN 1103 (also referred to as “shared spectrum cell 1103”) includes a macrocell in this example and supports communication on frequencies that are not solely licensed to a particular MNO, such as CBRS for example, and thus may service user mobile communication devices 1108(1)-1108(N) independent of a particular MNO. The macrocell 1102 can be or include a wireless device(s) that can be configured to selectively control whether received transmit channels are transmitted through an antenna array of the wireless device. The macrocell 1102 can be a wireless device that can be configured to selectively control whether received transmit channels are transmitted through an antenna array of the wireless device. For example, the shared spectrum cell 1103 may be operated by a third party that is not an MNO and wherein the shared spectrum cell 1103 supports CBRS. The MNO macrocell 1102, the shared spectrum cell 1103, and the small cell RAN 1104 may be neighboring radio access systems to each other, meaning that some or all can be in proximity to each other such that a user mobile communication device 1108(3)-1108(N) may be able to be in communication range of two or more of the MNO microcell(s) 1102, the shared spectrum cell 1103, and the small cell RAN 1104 depending on the location of the user mobile communication devices 1108(3)-1108(N).

In FIG. 11, the multi-radio WCS 1100 in this example is arranged as an LTE system as described by the Third Generation Partnership Project (3GPP) as an evolution of the GSM/UMTS standards (Global System for Mobile Communication/Universal Mobile Telecommunication System). It is emphasized, however, that the aspects described herein may also be applicable to other network types and protocols. The multi-radio WCS 1100 includes the enterprise environment 1106 in which the small cell RAN 1104 is implemented. The small cell RAN 1104 includes a plurality of small cell radio nodes 1112(1)-1112(C), which are wireless devices that can be configured to selectively control whether received transmit channels are transmitted through an antenna array of the wireless devices. Each small cell radio node 1112(1)-1112(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 11, the small cell RAN 1104 includes one or more services nodes (represented as a single services node 1114) that manage and control the small cell radio nodes 1112(1)-1112(C). In alternative implementations, the management and control functionality may be incorporated into a radio node, distributed among nodes, or implemented remotely (i.e., using infrastructure external to the small cell RAN 1104). The small cell radio nodes 1112(1)-1112(C) are coupled to the services node 1114 over a direct or local area network (LAN) connection 1116 as an example, typically using secure IPsec tunnels. The small cell radio nodes 1112(1)-1112(C) can include multi-operator radio nodes. The services node 1114 aggregates voice and data traffic from the small cell radio nodes 1112(1)-1112(C) and provides connectivity over an IPsec tunnel to a security gateway (SeGW) 1111 in a network 1120 (e.g., evolved packet core (EPC) network in a 4G network, or 5G Core in a 5G network) of the MNO 1110. The network 1120 is typically configured to communicate with a public switched telephone network (PSTN) 1122 to carry circuit-switched traffic, as well as for communicating with an external packet-switched network such as the Internet 1124.

The multi-radio WCS 1100 also generally includes a node (e.g., eNodeB or gNodeB) base station, or “macrocell” 1102. The radio coverage area of the macrocell 1102 is typically much larger than that of a small cell where the extent of coverage often depends on the base station configuration and surrounding geography. Thus, a given user mobile communication device 1108(3)-1108(N) may achieve connectivity to the network 1120 (e.g., EPC network in a 4G network or 5G Core in a 5G network) through either a macrocell 1102 or small cell radio node 1112(1)-1112(C) in the small cell RAN 1104 in the multi-radio WCS 1100.

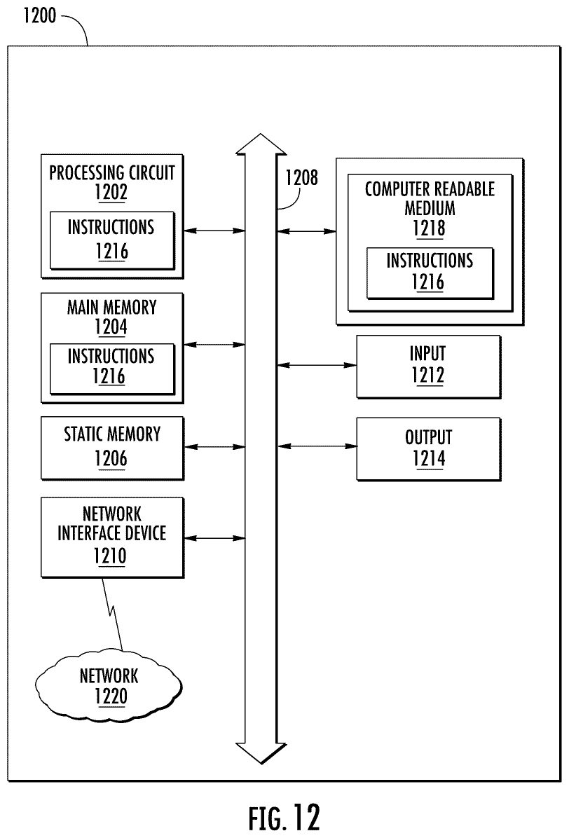

Any of the circuits, components, devices, or modules described herein can include or be included in a computer system 1200, such as that shown in FIG. 12, to carry out their functions and operations as described herein. With reference to FIG. 12, the computer system 1200 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1200 in this embodiment includes a processing circuit 1202 (e.g., processor), a main memory 1204 (e.g., read-only memory (ROM), flash memory, dynamic random-access memory (DRAM) such as synchronous DRAM (SDRAM), etc.), and a static memory 1206 (e.g., flash memory, static random-access memory (SRAM), etc.), which may communicate with each other via a data bus 1208. Alternatively, the processing circuit 1202 may be connected to the main memory 1204 and/or static memory 1206 directly or via some other connectivity means. The processing circuit 1202 may be a controller, and the main memory 1204 or static memory 1206 may be any type of memory.

The processing circuit 1202 represents one or more general-purpose processing circuits such as a microprocessor, central processing unit, or the like. More particularly, the processing circuit 1202 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1202 is configured to execute processing logic in instructions 1216 for performing the operations and steps discussed herein.

The computer system 1200 may further include a network interface device 1210. The computer system 1200 also may or may not include an input 1212 to receive input and selections to be communicated to the computer system 1200 when executing instructions. The computer system 1200 also may or may not include an output 1214, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1200 may or may not include a data storage device that includes instructions 1216 stored in a computer-readable medium 1218. The instructions 1216 may also reside, completely or at least partially, within the main memory 1204 and/or within the processing circuit 1202 during execution thereof by the computer system 1200, the main memory 1204 and the processing circuit 1202 also constituting the computer-readable medium 1218. The instructions 1216 may further be transmitted or received over a network 1220 via the network interface device 1210.

While the computer-readable medium 1218 is shown in an exemplary embodiment to be a single medium, the term “computer-readable medium” should be taken to include a single medium or multiple media (e.g., a centralized or distributed database and/or associated caches and servers) that store the one or more sets of instructions. The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. The terms “computer-readable medium” and “machine-readable medium” shall also be taken to include any medium that is capable of storing or encoding a set of instructions for execution by the processing circuit and that causes the processing circuit to perform any one or more of the methodologies of the embodiments disclosed herein. For example, a computer-readable medium or a machine-readable medium includes a machine-readable storage medium (e.g., read-only memory (“ROM”), random access memory (“RAM”), magnetic disk storage medium, optical storage medium, flash memory devices, etc.), solid-state memories, optical media, magnetic media, and the like. Notwithstanding this broad definition, specifically excluded from this definition are electromagnetic carrier waves or other signals that have information encoded thereon or therein but lack tangible form.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

Unless specifically stated otherwise and as apparent from the previous discussion, it is appreciated that throughout the description, discussions utilizing terms such as “processing,” “computing,” “determining,” “displaying,” or the like refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips that may be referenced throughout the above description may be represented by voltages, currents, electromagnetic waves, magnetic fields, optical fields, or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A wireless communication system (WCS) comprising:
a remote antenna unit (RAU) configured to communicate with user equipment in a service area;
a distribution unit (DU) communicatively coupled to the RAU and comprising a DU processor comprising a radio link control (RLC) sublayer, the RLC sublayer configured to:
send an initial credit value to a packet data convergence protocol (PDCP) sublayer;
track redemption of credits by the PDCP sublayer as evidenced by receipt of packets;
determine whether the redemption of credits causes a local credit value to pass a threshold; and
in response to the redemption of credits causing the local credit value to pass the threshold, send additional credits to the PDCP sublayer; and
a central unit (CU) comprising a CU processor comprising the PDCP sublayer, the PDCP sublayer configured to:
receive the initial credit value from a radio link control (RLC) sublayer;
decrement the initial credit value based on packets sent from the PDCP sublayer to the RLC sublayer to create a remaining credit value;
receive a subsequent credit value from the RLC sublayer;
in response to receipt of the subsequent credit value from the RLC sublayer, add the subsequent credit value to the remaining credit value.

2. The WCS of claim 1, wherein the RLC sublayer is further configured to start a timer.

3. The WCS of claim 2, wherein the RLC sublayer is further configured to send an incremental credit amount on expiration of the timer even if the threshold has not been passed.

4. The WCS of claim 1, wherein the packets comprise service data units (SDUs).

5. The WCS of claim 1, wherein the RLC sublayer is configured to calculate a maximum credit value, and the initial credit value is set to the maximum credit value.

6. The WCS of claim 1, wherein the PDCP sublayer is configured to discard all credits and stop sending packets on receiving an interrupt value from the RLC sublayer.

7. A device in a wireless communication system (WCS), comprising:
a processor comprising a radio link control (RLC) sublayer, the RLC sublayer configured to:
send an initial credit value to a packet data convergence protocol (PDCP) sublayer;
track redemption of credits by the PDCP sublayer as evidenced by receipt of packets;
determine whether the redemption of credits causes a local credit value to pass a threshold; and
in response to the redemption of credits causing the local credit value to pass the threshold, send additional credits to the PDCP sublayer.

8. The device of claim 7, wherein the device comprises a distribution unit (DU).

9. The device of claim 8, wherein the DU comprises the PDCP sublayer.

10. The device of claim 7, wherein the device comprises a control unit (CU) in a WCS.

11. The device of claim 10, wherein the CU comprises the PDCP sublayer.

12. The device of claim 7, wherein the RLC sublayer is configured to send the initial credit value to a second device having the PDCP sublayer.

13. The device of claim 7, wherein the RLC sublayer is further configured to start a timer.

14. The device of claim 13, wherein the RLC sublayer is further configured to send an incremental credit amount on expiration of the timer even if the threshold has not been passed.

15. The device of claim 7, wherein the packets comprise service data units (SDUs).

16. The device of claim 7, wherein the RLC sublayer is configured to calculate a maximum credit value, and the initial credit value is set to the maximum credit value.

17. A device in a wireless communication system (WCS), comprising:
a processor comprising a packet data convergence protocol (PDCP) sublayer, the PDCP sublayer configured to:
receive an initial credit value from a radio link control (RLC) sublayer;
decrement the initial credit value based on packets sent from the PDCP sublayer to the RLC sublayer to create a remaining credit value; and
receive a subsequent credit value from the RLC sublayer;
in response to receipt of the subsequent credit value from the RLC sublayer, add the subsequent credit value to the remaining credit value.

18. The device of claim 17, wherein the device comprises a distribution unit (DU).

19. The device of claim 18, wherein the DU comprises the RLC sublayer.

20. The device of claim 17, wherein the device comprises a control unit (CU).

21. The device of claim 20, wherein the CU comprises the RLC sublayer.

22. The device of claim 17, wherein the PDCP sublayer is configured to receive the initial credit value from a second device having the RLC sublayer.

23. The device of claim 17, wherein the packets comprise service data units (SDUs).

24. The device of claim 17, wherein the PDCP sublayer is configured to discard all credits and stop sending packets on receiving an interrupt value from the RLC sublayer.

25. A method of controlling packet flow in a wireless communication system (WCS), comprising:
sending an initial credit value from a radio link control (RLC) sublayer to a packet data convergence protocol (PDCP) sublayer;
at the PDCP sublayer, receiving the initial credit value from the RLC sublayer;
sending packets from the PDCP sublayer to the RLC sublayer;
in response to sending packets, decrement the initial credit value at the PDCP sublayer by a number of packets sent;
in response to receiving packets at the RLC sublayer, tracking redemption of credits by the PDCP sublayer;
determining whether the redemption of credits causes a local credit value to pass a threshold; and
in response to the redemption of credits causing the local credit value at the RLC sublayer to pass a threshold, send additional credits to the PDCP sublayer.
